(19) United States
(12) Patent Application Publication
(10) Pub. No.: US 2006/0135200 A1
(43) Pub. Date: Jun. 22, 2006

(54) Method for transmitting massive data effectively on multi-mode terminal

(76) Inventors: Min-Hong Yun, Seoul (KR); Do-Hyung Kim, Daejon (KR); Sun-Ja Kim, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/201,719

(22) Filed: Aug. 11, 2005

(30) Foreign Application Priority Data
Dec. 16, 2004 (KR) 10-2004-0107200

(51) Int. Cl. H04M 1/00

(52) U.S. Cl. 455/552.1; 455/422.1

(57) ABSTRACT

Provided is a method for transporting massive data effectively on a multi-mode terminal for saving a cost and time required for transmitting massive data by separately transmitting basic information required for accessing to the massive data and real massive data, considering economical and technical characteristics of each network in a multi-mode terminal which supports heterogeneous networks. The method for transmitting massive data effectively on a multi-mode terminal includes the steps of: requesting a multimode terminal to download massive data, the multimode terminal supporting a narrowband wireless network and a broadband wireless network; obtaining basic information required for downloading the massive data requested through a narrowband wireless network in the multimode terminal; and downloading the massive data requested from a contents server connected to an Internet by accessing to the broadband wireless network based on the basic information in the multimode terminal.

### FIELD OF THE INVENTION

The present invention relates to a method for transmitting massive data effectively on a multi-mode terminal; and, more particularly, to an effective massive data transmitting method in a multi-mode terminal to save a cost and time consumed for transmitting massive data by separately transmitting basic information required for accessing to the massive data and real massive data, in consideration of economical and technical characteristics of each network in a multi-mode terminal which supports heterogeneous networks.

### DESCRIPTION OF RELATED ART

A multimedia messaging service (MMS) is a service for transmitting/receiving a multimedia presentation by a proper combination of an image, an audio, a video as well as a text, while, a short messaging service (SMS) includes only text. An MMS related specification operated in a third Generation Partnership Project (3GPP) and “WAP Forum” is based on an MMS transmitting method by a store-and-forward. That is, an MMS message written by an MMS user agent passes through a local MMS rely/server including an MMS user agent and is stored in a foreign MMS relay/sever including a recipient. Also, a foreign MMS relay/sever on the receiving part receiving the MMS message from the local MMS rely/server on the transmitting part transmits only an MMS notification that a new MMS arrives to the recipient. Generally, the MMS notification uses a teleService identification (TID) of a pre-set SMS.

Meanwhile, the recipient receiving the MMS notification accesses to the foreign MMS relay/sever through a mobile communication network, and downloads massive multimedia messages. In this case, the user should bear an economic burden charging a high cost to use the mobile communication and it takes long time to download data due to a relatively slow bandwidth.

In case of accessing to a wireless Internet through a mobile phone and presenting massive contents such as a game or a moving picture to another mobile phone, an SMS notifying that massive contents arrive to a recipient is used. If the recipient wants to download the massive contents, the massive contents can be downloaded by using basic information which has been already included in the SMS. Herein, there is also a problem that the recipient should bear an economic burden of a high price since the recipient downloads the massive contents by using the mobile communication network and it takes long time to download due to a relatively slow bandwidth. There is the same problem in case of downloading the massive contents selected by the user.

A general network structure for transmitting/receiving a multimedia message will be described hereinafter referring to FIG. 1.

FIG. 1 is a diagram showing a conventional MMS system. As shown in FIG. 1, the conventional MMS system includes an MMS UA 101 on the transmitting part, a local MMS relay/server 103, a foreign MMS relay/server 104, an MMS UA 102 on the receiving part, an MMS user database 105, an SMS center 106 and an e-mail server 107. The MMS UA 101 on the transmitting part included in a transmitting terminal is used for writing the multimedia message and transmitting/receiving. The local MMS relay/server 103 receives the MMS message written by the MMS user agent and transmits the message to the foreign MMS relay/server. The foreign MMS relay/server 104 stores the MMS message transmitted by the local MMS relay/server on the transmitting part and communicates with a recipient terminal. The foreign MMS UA 102 on the receiving part included in the recipient terminal notifies an arrival of the multimedia message, receives the multimedia message, interprets and processes a required protocol. The MMS user database 105 is required to transmit/receive the MMS. The operation will be described referring to FIG. 2.

FIG. 2 is a signal flowchart showing a procedure transmitting/receiving a multimedia message in the conventional MMS system.

At step S201, the multimedia message written and transmitted in the MMS UA 21 on the transmitting part is transmitted to the MMS relay/server 22 on the transmitting part. At step S202, the MMS relay/server 22 on the transmitting part grasps a position of the recipient and transmits the multimedia message received from the MMS UA 21 on the transmitting part to the MMS relay/server 23 on the receiving part, in which the recipient is positioned.

At step S203, the MMS relay/server 23 on the receiving part stores the message received from the MMS relay/server 22 on the transmitting part and transmits a notification that the multimedia message has arrived in the MMS UA 24 on the receiving part.

At step S204, the MMS UA 24 on the receiving part requests the multimedia message transmission to the MMS relay/server 23 on the receiving part according to the request of the recipient and receives the multimedia message. At steps S205 to S210, if necessary, transmission and check results of the MMS are transmitted to the MMS UA 21 on the transmitting part.

The MMS transmitting/receiving method of the store-and-forward method described in the above is applied in a similar way to the case transmitting massive contents such as a game and a moving picture to another user by accessing to a wireless Internet through a mobile phone, which is called a present giving. That is, the MMS UA 21 on the transmitting part conforms to a user terminal transmitting the massive data such as a game and a multimedia, and the MMS UA 24 on the receiving part conforms to the recipient terminal of the massive data. Also, the MMS relay/server 22 on the transmitting part conforms to a server included in a mobile communication service provider that the MMS sender subscribes, or a server which belongs to a service company offering the massive data such as a game and a multimedia. The MMS relay/server 23 on the receiving part conforms to a server included in a mobile communication service provider that the recipient subscribes, or a server included in a service company offering the massive data. The store-and-forward method is applied to the case in the same way, and the recipient receives the notification about the multimedia message reception via an SMS including a specific teleservice identification (ID). Subsequently, if the recipient requests the multimedia message, the massive data are downloaded by accessing to the MMS relay/server 23 on the receiving part through the wireless Internet.

In the conventional method, in case of receiving the massive contents transmitted from another user, or downloading the massive contents that a user wants, the massive contents were received by using the same network used in a discovery procedure of the massive contents.

Therefore, since the massive contents are received through the narrowband wireless network in the conventional method, there are problems that the user can not make a call or transmit a short message while downloading the massive contents and that the user should bear the high price.

### SUMMARY OF THE INVENTION

It is, therefore, an object of the present invention to provide a method for transmitting massive data effectively on a multi-mode terminal that can reduce price and time required for transmitting massive data by separately transmitting basic information required for accessing to the massive data and real massive data, considering economical and technical characteristics of each network in a multi-mode terminal which supports heterogeneous networks.

Other objects and aspects of the invention will be understood by the following description and become more apparent from the embodiments in accordance with the present invention, which is set forth hereinafter. It will be also apparent that objects and aspects of the invention can be embodied easily by the means defined in the claims and combinations thereof.

In accordance with an aspect of the present invention, there is provided a method for transmitting massive data effectively on a multi-mode terminal, the method including the steps of: requesting a multimode terminal to download massive data, the multimode terminal supporting a broadband wireless network and a narrowband wireless network; obtaining basic information required for downloading the massive data requested through a narrowband wireless network in the multimode terminal; and downloading the massive data requested from a contents server connected to an Internet by accessing to the broadband wireless network based on the basic information in the multimode terminal.

In accordance with another aspect of the present invention, there is provided a method for transmitting massive data effectively on a multi-mode terminal, the method including the steps of: requesting the multimode terminal to download the massive data, the multimode terminal supporting a broadband wireless network such as WiBro and a narrowband wireless network such as CDMA network; obtaining basic information required for downloading the massive data requested through the narrowband wireless network in the multimode terminal; accessing to the broadband network and requesting transmission of the massive data based on the basic information in the multimode terminal; receiving the massive data via the narrowband wireless network connected through a pipe and stored in the storage server; and accessing to the broadband wireless network in the multimode terminal and downloading the massive data stored in the storage server.

In accordance with another aspect of the present invention, there is provided a method for transmitting massive data effectively on a multi-mode terminal, the method including the steps of: requesting the multimode terminal to download the massive data, supporting the broadband wireless network and the narrowband wireless network; obtaining basic information required for downloading the massive data requested through the narrowband wireless network in the multimode terminal; accessing to the contents server connected to the narrowband wireless network based on the basic information and requesting the transmission of the massive data in the multimode terminal; retrieving the massive data, transmitting the data to the narrowband wireless network and storing the data in a common server connected to the narrowband wireless network and the broadband wireless network in the contents server; and accessing to the common server through the broadband wireless network and downloading the requested massive data in the multimode terminal.

The present invention relates to a method for transmitting massive data effectively on a multi-mode terminal, and makes it possible that the multimode terminal accessible to the more than heterogeneous networks extracts a game, a multimedia file using basic information regarding URI, a size, a valid period, a user authentication method, and that the massive data can be received through the broadband wireless network by using the basic information which has been delivered via a narrowband wireless network.

Other objects and aspects of the invention will become apparent from the following description of the embodiments with reference to the accompanying drawings, therefore, those skilled in the art that the present invention is included can embody the technology concept and scope of the invention easily. In addition, if it is considered that detailed description on the prior art blur the point of the present invention, the detailed description will not be provided herein. The preferred embodiments of the present invention will be described in detail hereinafter with reference to the attached drawings.

### BRIEF DESCRIPTION OF THE DRAWINGS

The above and other objects and features of the present invention will become apparent from the following description of the preferred embodiments given in conjunction with the accompanying drawings, in which:

FIG. 1 is a diagram showing a conventional multimedia messaging service (MMS) system;

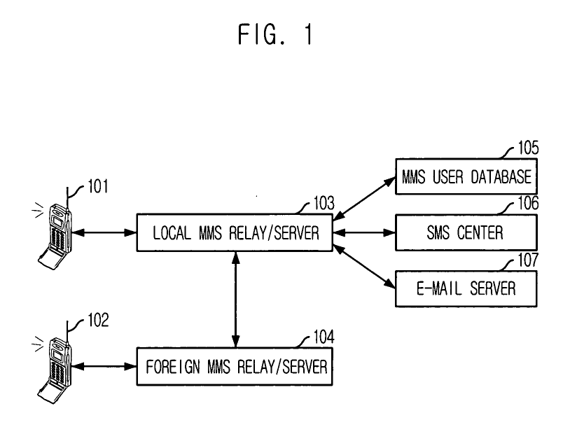

FIG. 2 is a signal flowchart showing a procedure transmitting/receiving a multimedia message in the conventional MMS system;

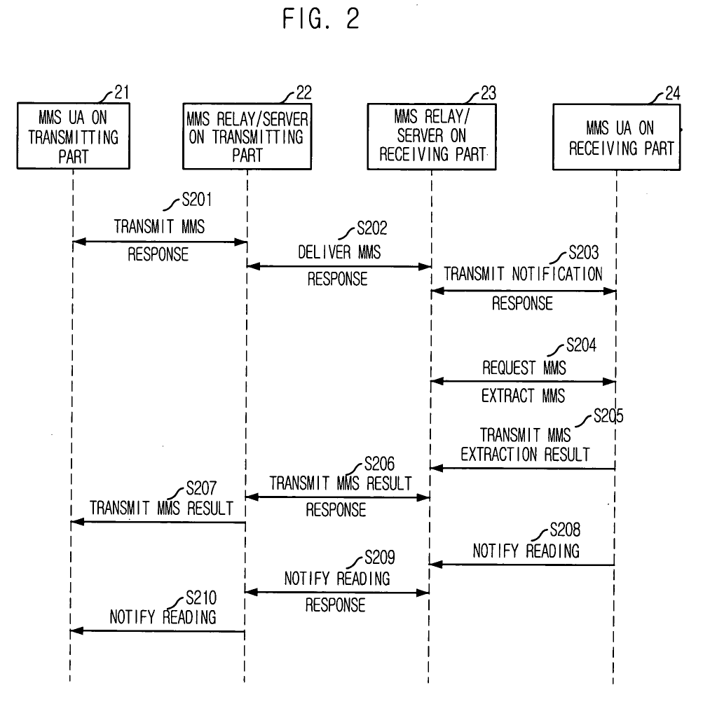

FIG. 3 is a diagram illustrating a transmission system of massive data in accordance with an embodiment of the present invention;

FIG. 4 is a diagram showing a transmission system of the massive data in accordance with an embodiment of the present invention; and

FIG. 5 is a diagram showing a transmission system of the massive data in accordance with an embodiment of the present invention.

### DETAILED DESCRIPTION OF THE INVENTION

Other objects and aspects of the invention will become apparent from the following description of the embodiments with reference to the accompanying drawings, which is set forth hereinafter.

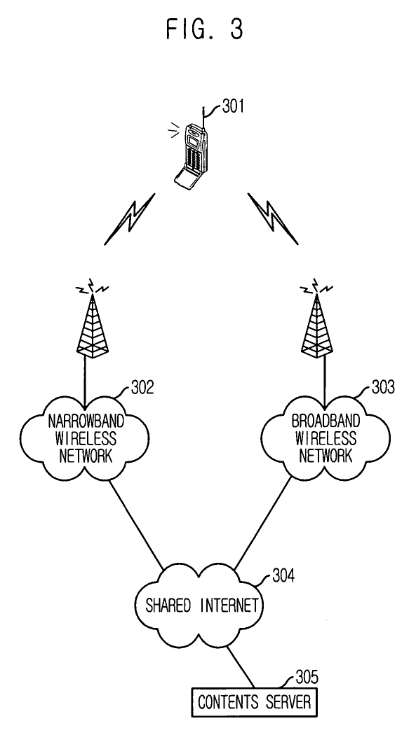

FIG. 3 is a diagram illustrating a transmission system of massive data in accordance with an embodiment of the present invention and shows a contents providing server positioned in a shared Internet.

As a dual-mode terminal 301 supporting narrowband wireless network such as a Code Division Multiple Access (CDMA) and a broadband wireless network such as a WiBro network is requested to download the massive data, e.g., a game and a multimedia, from the user, the dual-mode terminal 301 obtains basic information required for downloading, e.g., Uniform Resource Identifier (URI) of the massive data, a size, a valid period, a user authentication method and other basic information by accessing to a contents server 305 positioned in an Internet 304 through a narrowband wireless network 302. The dual-mode terminal 301 accesses to the broadband wireless network 303 and downloads the massive data from the contents server 305 positioned in the Internet 304.

Meanwhile, in case that the massive data such as a game or a moving picture existing on the Internet 304 are transmitted to other user terminal, the recipient terminal is notified by using the SMS of the narrowband wireless network 302 that the massive data have arrived, and the recipient terminal accesses to the contents server 305 through the broadband wireless network and downloads the massive data.

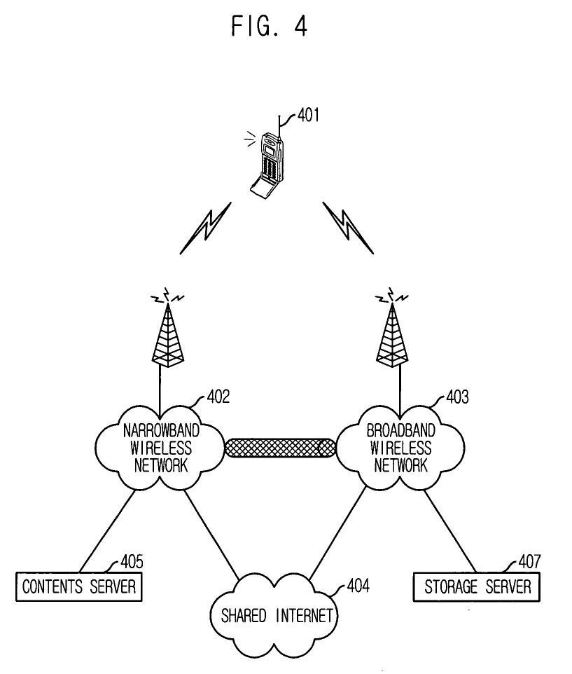

Thus, in the conventional method, the massive data are downloaded from the contents server 305 existing on the Internet 304 or transmitted to another terminal by accessing to the wireless Internet through the narrowband wireless network 302. However, in the present invention, the download of the massive data or the transmission to another terminal is requested through the narrowband wireless network 302, in fact, the procedure downloading the massive data or transmitting the data to another terminal is performed through the broadband wireless network. Therefore, the transmission rate is fast and it is inexpensive to receive/transmit the massive data. Another embodiment of the present invention will be described referring to FIG. 4.

FIG. 4 is a diagram showing a massive data transmission system in accordance with an embodiment of the present invention. It shows a method that a contents server 405 exists in a narrowband wireless network 402, and that the narrowband wireless network 402 and the broadband wireless network 403 are connected through a pipe.

As the dual-mode terminal 401 supporting the broadband wireless network and the narrowband wireless network is requested to download the massive data, e.g., a game and a multimedia, from the user, the dual-mode terminal 401 accesses to the contents server 405 through the narrowband wireless network 402 and obtains URI of the massive data, a size, a valid period, a user authentication and another basic information required for downloading.

Herein, the narrowband wireless network 402 and the broadband wireless network 403 are connected through the pipe to communicate with each other according to a designated protocol, or simply connected.

When the narrowband wireless network 402 and the broadband wireless network 403 communicate through the pipe 406, the dual-mode terminal 401 accesses to the broadband wireless network 403, reads the massive contents from the contents server 405 by using the obtained basic information, and stores the contents in the storage server 407 which is connected to the broadband wireless network.

Also, when the narrowband wireless network 402 and the broadband wireless network 403 are simply connected through the pipe 406, the dual-mode terminal 401 accesses to the contents server 405 after going through the broadband wireless network 403 and the narrowband wireless network 402, and downloads the massive contents based on the obtained basic information.

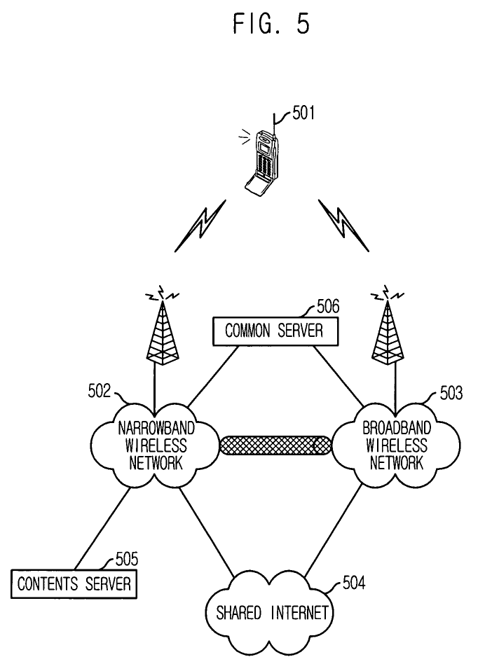

Meanwhile, when the massive data such as a game or a moving picture are transmitted, which is a present giving, to another user terminal while the broadband wireless network 403 and the narrowband wireless network 402 are connected through the pipe 406, the user terminal is notified that the massive data have arrived by using the SMS of the narrowband wireless network 402. Also, the terminal notified the arrival of the massive data accesses to the contents server 305 through the broadband wireless network and downloads the massive data. Another embodiment of the present invention will be described hereinafter referring to FIG. 5.

FIG. 5 is a diagram showing a transmission system of the massive data in accordance with an embodiment of the present invention and shows the case that a contents server 505 exists on a narrowband wireless network 502 and a common server 506 exists between the narrowband wireless network 502 and a broadband wireless network 503.

As the dual-mode terminal 501 supporting the narrowband wireless network and the broadband wireless network is requested to download the massive data, e.g., a game and a multimedia, from the user, the dual-mode terminal 501 accesses to the contents server 505 through the narrowband wireless network 502 and obtains URI of the massive data, a size, a valid period, a user authentication and another basic information required for downloading.

If the dual-mode terminal 501 requests the transmission of the massive data based on the obtained basic information, the contents server 505 searches the massive data, transmits the data through the narrowband wireless network 502 and stores the data in the common server 506 existing between the narrowband wireless network 502 and the broadband wireless network 503. Subsequently, the dual-mode terminal 501 accesses to the common server 506 through the broadband wireless network 503 and downloads the massive data based on the obtained basic information.

Meanwhile, when the massive data such as a game or a moving picture are transmitted, which is a present giving, to another user terminal while the common server 506 exists between the narrowband wireless network 502 and the broadband wireless network 503, the arrival of the massive data is notified to the terminal on the receiving part by using the SMS of the narrowband wireless network 402. Also, the terminal on the receiving part notified of the arrival of the massive data accesses to the common server 506 through the broadband wireless network 503 and downloads the massive data. For example, if the dual-mode terminal accessible to the narrowband wireless network and the broadband wireless network is notified of the arrival of the multimedia message through the narrowband wireless network, it can be realized to check the multimedia message by using the moderate broadband wireless network instead of the expensive narrowband wireless network.

The present invention makes it possible to receive the massive contents effectively considering the economical and technical characteristics of each network in the multi-mode terminal supporting the heterogeneous networks access. That is, when the present invention downloads the massive data such as a multimedia message and multimedia contents in the multi-mode terminal supporting the heterogeneous networks access, the economical and technical characteristics of each network are considered, thereby obtaining URI, a size, a valid period, a user authentication method and another basic information of the storage, in which the massive data exist, by using the accessible network such as the narrowband wireless network, and downloading the massive data such as a game and multimedia data by using the wide bandwidth network such as the broadband wireless network.

The user can save the cost and time by separately transmitting the basic information for accessing to the massive data and the real massive data according to the characteristics of the heterogeneous networks. For example, the dual-mode terminal supporting the narrowband wireless network and the broadband wireless network searches the massive data to download through the wireless Internet offering in the narrowband wireless network and receives the basic information required for accessing to the massive data. Also, the massive data are downloaded by using the received basic information. Herein, the download of the massive data is completed through the broadband wireless network.

As described in detail, the present invention can be embodied as a program and stored in a computer-readable recording medium, such as CD-ROM, RAM, ROM, a floppy disk, a hard disk and a magneto-optical disk. Since the process can be easily implemented by those skilled in the art, further description will not be provided herein.

The present invention makes it possible to save the cost and time for transmitting the massive data by separately transmitting the basic information for accessing to the massive data and the real massive data, in consideration of the economical and technical characteristics of each network in the multi-mode terminal supporting the heterogeneous networks.

The present application contains object matter related to Korean patent application No. 2004-0107200, filed with the Korean Intellectual Property Office on Dec. 16, 2004, the entire contents of which is incorporated herein by reference.

While the present invention has been described with respect to certain preferred embodiments, it will be apparent to those skilled in the art that various changes and modifications may be made without departing from the scope of the invention as defined in the following claims.

What is claimed is:

1. A method for transmitting massive data effectively on a multi-mode terminal, comprising the steps of:
a) requesting a multimode terminal to download massive data, the multimode terminal supporting a narrowband wireless network and a broadband wireless network;
b) obtaining basic information required for downloading the massive data requested through a narrowband wireless network in the multimode terminal; and
c) downloading the massive data requested from a contents server connected to the Internet by accessing to the broadband wireless network based on the basic information in the multimode terminal.

2. The method as recited in claim 1, further comprising steps of:
d) notifying the terminal on a receiving part that the massive data have arrived by using a short messaging service (SMS) of the narrowband wireless network in the multimode terminal; and
e) accessing to the broadband wireless network and downloading the massive data from the contents server connected to the Internet in the terminal on the receiving part.

3. A method for transmitting massive data effectively in a multi-mode terminal, comprising the steps of:
a) requesting the multimode terminal to download the massive data, the multimode terminal supporting a narrowband wireless network and a broadband wireless network;
b) obtaining basic information required for downloading the massive data requested through the narrowband wireless network in the multimode terminal;
c) accessing to the broadband wireless network and requesting transmission of the massive data based on the data information in the multimode terminal;
d) receiving the massive data via the narrowband wireless network connected through a pipe and stored in the storage server; and
e) accessing to the broadband wireless network in the multimode terminal and downloading the massive data stored in the storage server.

4. The method as recited in claim 1, further comprising the step of:
f) accessing to the broadband wireless network in the multimode terminal and downloading the requested massive data via the narrowband wireless network connected through the pipe.

5. A method for transmitting massive data effectively on a multi-mode terminal, comprising the steps of:
a) requesting the multimode terminal to download the massive data, supporting the narrowband wireless network and the broadband wireless network;
b) obtaining basic information required for downloading the massive data requested through the narrowband wireless network in the multimode terminal;
c) accessing to the contents server connected to the narrowband wireless network based on the basic information and requesting the transmission of the massive data in the multimode terminal;
d) retrieving the massive data, transmitting the data to the narrowband wireless network and storing the data in a common server connected to the narrowband wireless and the broadband wireless network in the contents server; and
e) accessing to the common server through the broadband wireless network and downloading the requested massive data in the multimode terminal.

6. The method as recited in claim 5, further comprising the steps of:
f) notifying the terminal on a receiving part that the massive data have arrived by using an SMS of the narrowband wireless network in the multimode terminal; and
g) accessing to the broadband wireless network and downloading the massive data from the common server in the terminal on the receiving part.
